(19) United States
(12) Patent Application Publication
(10) Pub. No.: US 2006/0026075 A1
(43) Pub. Date: Feb. 2, 2006

(54) System and method for workload distribution

(76) Inventors: Dave Dickerson, Cota de Caza, CA (US); Catherine Aldrich, Huntington Beach, CA (US); Rebecca Sargent, Santa Ana, CA (US)

Correspondence Address: FOLEY & LARDNER LLP, P.O. BOX 80278, SAN DIEGO, CA, 92138-0278, US

(21) Appl. No.: 10/909,203

(22) Filed: Jul. 29, 2004

(51) Int. Cl. G06Q 30/00

(52) U.S. Cl. 705/26

(57) ABSTRACT

The disclosed embodiments provide methods and systems for distributing workload related to verifications. The workload is distributed among a large number of affiliates through a central server. The central server can receive verification requests from clients and makes the requests available to the affiliates. The affiliates can perform the verifications by, for example, calling the verifiers and can return the results back to the central server. A method of distributing workload includes receiving a verification request from a client, making the request electronically available to a plurality of affiliates, transferring the request electronically to one or more of the plurality of affiliates for fulfillment of the request, the fulfillment including contacting at least one verifier included in the request, and receiving results of the request fulfillment from the one or more affiliates.

### BACKGROUND OF THE INVENTION

The present invention relates generally to the field of workflow management. In particular, the invention relates to systems and methods of distribution of workload in verification systems such as, for example, employment, background, income, character and other verification systems.

Verifications of information can be a critical part of a business. For example, companies hiring an individual applicant for a critical post must be confident of the qualifications of the applicant. Often, such qualifications are determined based on the credentials and past work history of the applicant. A hiring employer is often forced to trust the information provided by the applicant relating to credentials and work history.

Such trust can often be misplaced. One study has estimated approximately 30 million employees obtained their jobs through fraudulent resumes. Background verifications can be useful in detecting discrepancies or misstatements in resumes. Unfortunately, performing such background verifications on all qualified applicants can be a time-consuming process, particularly if a company is in the midst of a hiring frenzy. Hiring a large human resources department to do the work may be wasteful, since the work required may be a short-term project.

### SUMMARY OF THE INVENTION

The disclosed embodiments provide methods and systems for distributing workload related to verifications. The workload is distributed among a large number of affiliates through a central server. The central server can receive verification requests from clients and makes the requests available to the affiliates. The affiliates can perform the verifications by, for example, calling the verifiers and can return the results back to the central server.

In one aspect, the invention includes a method of distributing workload. The method includes receiving a verification request from a client, making the request electronically available to a plurality of affiliates, transferring the request electronically to one or more of the plurality of affiliates for fulfillment of the request, the fulfillment including contacting at least one verifier included in the request, and receiving results of the request fulfillment from the one or more affiliates.

As used herein, “distributing” includes allocating, assigning or otherwise associating a task to an affiliate.

As used herein, “workload” refers to the plurality of tasks to be completed.

“Verification request” refers to any of a variety of requests requiring verification of information related to an individual. The information may relate to, without limitation, credentials, such as colleges attended degrees earned, work history, income or character.

A “client” may include an individual, an entity, or a computer requesting a verification.

The term “affiliates” refers to individuals, entities or computers adapted to perform verifications. In one embodiment, the term “affiliates” includes sub-affiliates to whom work has been further distributed by other affiliates.

As used herein, “contacting” includes calling by telephone, sending an electronic mail message, sending a facsimile, or using other modes of communication.

In another aspect, the invention includes a workload distribution system. The system includes a central server adapted to receive a verification request from a client and a plurality of affiliate computers adapted to access the request from the server for fulfillment of the request, fulfillment of said request including contacting at least one verifier included in the request.

### BRIEF DESCRIPTION OF THE DRAWINGS

FIG. 1 is a schematic illustration of an embodiment of a workload distribution architecture; and

FIG. 2 is a flow chart illustrating an exemplary workflow process.

### DETAILED DESCRIPTION OF THE PREFERRED EMBODIMENTS

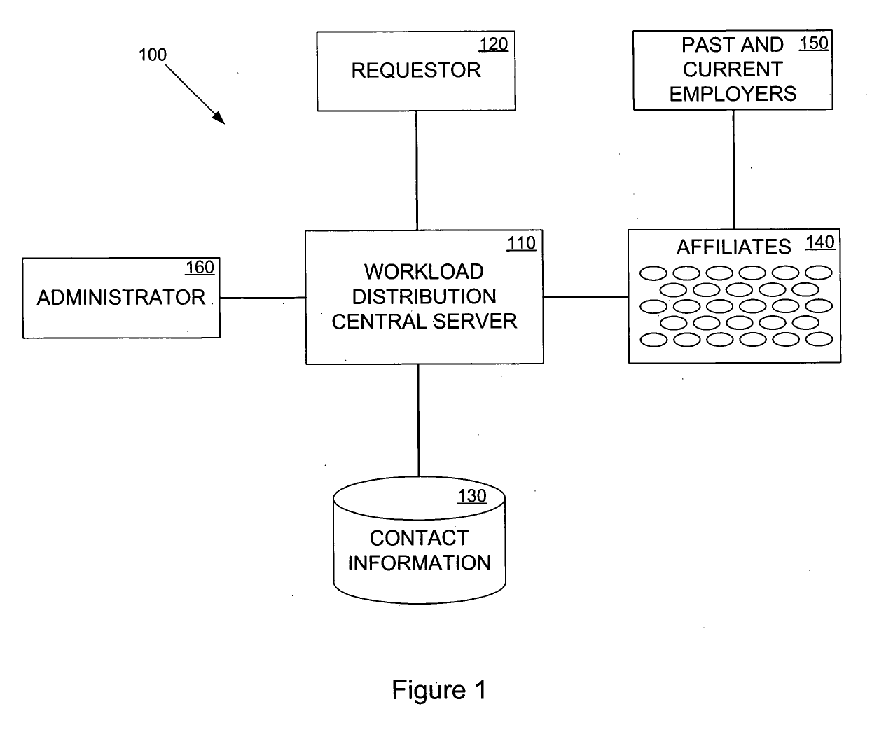

Referring to FIG. 1, an embodiment of an architecture for a workload distribution system is illustrated. The workload distribution architecture may be adapted for use in various environments. For purposes of illustration, an implementation of the architecture in a verification environment will be described.

The exemplary workload distribution system 100 includes a central server 110 for receiving work requests from a requester client 120. The central server 110 is a computer or a network of computers provided with server software. The server 110 may be provided with additional software to perform additional functions, as are described in greater detail below.

The work requests received from the requestor client 120 may be received in a variety of manners. In one embodiment, the requests are received as messages transmitted through a network, such as the Internet or a secure extranet, for example. In this regard, the requester client 120 is a computer with the capability for networked communication. For example, the requests may be transmitted as an electronic mail message. In a particular embodiment, the requests are submitted as data entered into forms on a web page hosted by the server 110.

In the verification environment, the requestor client may be a computer operated by an employer. The work request may be a request to verify information provided by an applicant or a potential new employee. For example, an applicant may have provided the employer with past employment history which the employer wishes to verify prior to hiring the applicant. In this regard, the employer may forward information relating to prior employers of the applicant, for example, including applicant's name, any aliases, date of birth, social security or identification number, name of prior employer, position or title last held by applicant, dates of employment and a reason for leaving.

Once a work request is received by the central server 110, the central server 110 may maintain current status of each work request. In this regard, the central server 110 may track progress of that work request at each step until the results of that work request are returned to the requestor client 120. For example, once the work request has been received, the central server 110 may list the status of the work request as “PENDING”. While the work request is being fulfilled, the status may be changed to “IN PROGRESS”. The status of each work request may be made available to the requester client 120 through a web page, for example.

The system 100 also includes a data store 130 adapted to store contact information for various entities, such as employers. The data store 130 may be provided in any number of forms, such as a database or a table. In a particular embodiment, the data store 130 includes a searchable database. The data store 130 is adapted to be accessed by the central server 110 and by certain other components of the system 100 through the central server 110. Although FIG. 1 illustrates the data store 130 as a separate component from the central server 110, in certain embodiments, the data store 130 may be integral with the central server 110.

The central server 110 may be accessible by a plurality of affiliates 140 who have been pre-approved for such access, for example. The affiliates may be individuals or entities with computers able to access the central server 110. The affiliates 140 may be independent contractors that are paid, for example, on a per-verification basis. In this regard, a large number of affiliates may be available for large verification tasks. Further, the affiliates may be spread across a vast geographic region.

The communication between the individual affiliates 140 and the central server 110 may be through a variety of means, such as through a communication network. In a particular embodiment, an affiliate 140 accesses the central server 110 through the Internet or an extranet.

During an approval process for the affiliates 140, each affiliate 140 may be required to provide certain information to the central server 110. This affiliate information may be stored on the central server 110, in the contact information data store 130 or in another storage area. The affiliate information may include the contact information for the affiliate 140. In addition, in the exemplary verification environment, the affiliate information may include the hours an individual affiliate is available, the geographic region of the affiliate and the workload requested. In addition to the affiliate information provided by the affiliate 140, the central server 110 may store additional information for each affiliate, such as information relating to the performance characteristics of the affiliate 140, as described below.

The affiliates 140 are allowed access to the central server 110 to obtain or be assigned a work request. For example, in the verification environment, an affiliate 140 may obtain one or more past-employer verification requests from a requestor client 120. In this regard, once a work request or a portion of a work request (e.g., one of three past employers for an individual applicant) has been assigned to an affiliate 140, the central server 110 may change the status of that work request as “IN PROGRESS,” for example.

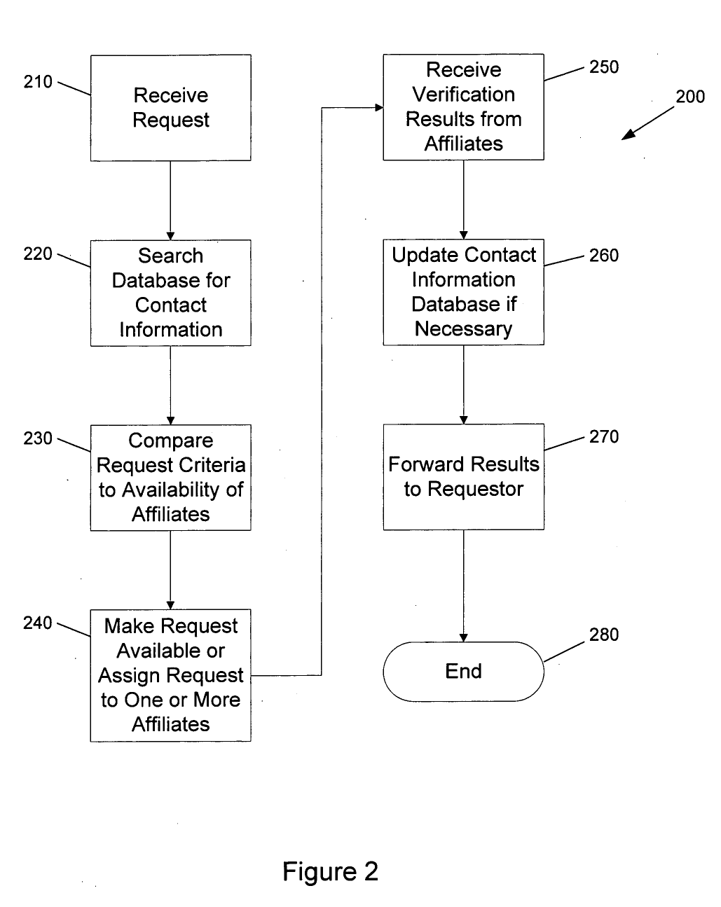

The affiliate 140 may be provided with contact information for a verifier 150, which may be, for example, a past or current employer of the applicant, educational institution, business partner, reference, associate, co-worker, landlord, or creditor. The contact information may be obtained from the work request itself or from the contact information data store 130, as described below with reference to FIG. 2. Further, the affiliate may manually search the data store 130 for the contact information. In addition to the contact information and the information provided by the applicant, an affiliate may be provided with a script to follow when telephonic contact is made with the past employer. The script may include appropriate questions to ask to not only verify the applicant's background or other information, but also to ensure that the correct individual or entity within the past employer has been contacted.

In one embodiment, affiliates may be allowed to further distribute the workload to sub-affiliates. In this regard, the sub-affiliates perform the verifications, and the results may be reported either directly by the sub-affiliates to the central server or first from the sub-affiliates to the affiliates, who report to the central server.

An administrator module 160 may be provided to manage and evaluate the performance of the affiliates. The administrator module 160 may include an automated set of checks and audits to evaluate the performance of an affiliate. For example, the administrator module 160 may assign “seed” requests to an affiliate. Seed request refers to false requests intended to test the performance of the affiliate. For example, an affiliate may be provided with a work request which including contact information that leads the affiliate to a test center acting as a past employer. Other audits may include re-assigning a work request performed by an affiliate to a second affiliate. Comparing the results of the two affiliates can provide an indication of the accuracy of the results obtained by each affiliate.

In addition to the checks and audits, the administrator module 160 may maintain a profile for each affiliate. The profile may include the information provided by the affiliate, including contact information and hours available, as well as information determined by the administrator module 160. For example, based on the affiliate's performance and availability, the administrator module 160 may determine that the number of work requests that can be assigned to the affiliate at any one time should be limited. Thus, the affiliate's profile may include a maximum value.

The affiliates' profiles may be used to match affiliates with a particular work request. For example, the profile may include such information as language skills, industry experience, geographic location, skill set and tenure on the system 100. In certain cases, a work request may require one or more specialized qualifications of the affiliate, and the profile may be used to select one or more candidate affiliates for the work request. For example, if a work request may require contacting an employer in Japan, an affiliate with Japanese language skills may be preferred.

The administrator module 160 may also maintain statistics on the performance of each affiliate. The statistics may include such information as how long an affiliate has worked, percentage of requests being returned as verified, not verified, returned noting a discrepancy and returned with additional information. The additional information may include updated contact information for the past employer to be included in the contact information data store 130. In this regard, the data store 130 may be continuously growing and updated. As described below, the additional information may include other information, such as salary information, obtained or derived by the affiliate.

In certain embodiments, the function of the administrator module 160 may be performed manually. In this regard, an administrator may manually review the statistics to evaluate the affiliates and may manually cause the execution of checks and audits.

As noted above, the data store 130 is adapted to store contact information for certain entities, referred to herein as verifiers. The contact information may include phone numbers, fax numbers, e-mail addresses, and other information that may be useful in contacting the verifiers. Further, the contact information may include references to any special procedures a verifier may have for verification of information. For example, the contact information for a verifier may include a form to be filled out and signed by the applicant.

In addition to storing contact information, the data store 130 may be adapted to store information relating to the applicant. For example, once a work request relating to a particular applicant is completed, the results can be stored in the data store 130. The storage of the results may include any level of data desired. For example, in one embodiment, all information relating to the applicant, including information provided by the requestor client and the applicant and information obtained by the affiliates, can be stored. Thus, if a work request is received for the same applicant from, for example, a different requestor client, the stored information may be used as a starting point for the verification, and repeating of work can be avoided.

Referring now to FIG. 2, an embodiment of a workload distribution method will be described. Again, the exemplary verification environment is described for illustrative purposes. The process 200 begins when a work request is received by the central server (block 210). As noted above, the work request may include certain information to be verified for an applicant and may be received through a communication network such as the Internet. A work request may be received in a batch form. For example, a client may send information for several hundred applicants to be verified. Requests from additional clients may be received either in parallel or in sequence.

Upon receiving the work request, the central server searches the data store for contact information relating to past employers noted in the work request (block 220). As noted above, the data store may contain various types of information relating to entities which may include past employers. In particular, the data store may include contact information for an individual, a department or an entity to be contacted for employment verification. For example, an applicant listing Acme Corporation as a past or current employer may include the contact information for his immediate supervisor. However, from either past experience or otherwise, the system may have learned that all employment verification requests must be directed to the Human Resources department at Acme Corporation. Accordingly, the data store may include contact information for the Human Resources department. The contact information may be accompanied by a textual comment including special instructions for Acme Corporation.

If such contact information is found in the data store, the central server may attach the contact information to the work request, indicating the data store as the source. Thus, the work request may now include the original contact information provided by the applicant or the requestor client and the contact information found in the data store. If no contact information is found in the data store, the contact information provided by the requestor client or the applicant may be added to the data store.

In certain embodiments, the central server may compare criteria or requirements of the work request with the availability of affiliates (block 230). For example, the requestor client or the applicant may have included requirements in the work request that the past or current employer be contacted only at certain times or only by individuals in a certain geographic region. In such cases, the central server may determine which of the available affiliates satisfies the criteria. In this regard, as described above, the affiliates' profiles may be used to match affiliates with particular work requests using information in the profiles relating to language skills, industry experience, geographic location, skill set and tenure on the system, for example.

The availability of the affiliates may also be affected by such factors as the current workload. For example, if certain affiliates currently have assigned to them a large number of work requests, the central server may exclude those affiliates from availability. As described above, the determination of a maximum number of work requests an affiliate can be assigned may be based on several factors, including the hours the affiliate is available and the affiliate's performance.

At block 240, the central server makes the work request available to or assigns the work request to one or more affiliates. In one embodiment, the work request is posted as available on a website hosted by the central server for access by the affiliates. In this regard, the work request may be posted for access only by those affiliates satisfying the criteria in block 230. Any of the available affiliates may select the work request for themselves. In other embodiments, the central server may assign the work request to one or more specific affiliates. If an affiliate does not accept the assignment, the central server may re-assign to another affiliate.

The assigned affiliates may then fulfill the work request offline or online. In this regard, the affiliates may contact the past or current employers though telephone calls, electronic mail messages, faxes or other modes of communication.

Once the affiliate has completed the work request, the affiliate may transfer the results to the central server through the web site or through electronic mail messages. The central server thus receives the results from the affiliate (block 250). The received results may include a variety of indicators. For example, one result indicator may be “VERIFIED,” denoting a successful verification of the information provided in the work request.

Another result indicator may be “NOT VERIFIED,” indicating that the information could not be verified. This result may occur, for example, if the affiliate was unable to make contact with the past or current employer for any reason. For example, the affiliate may not have received an answer to inquiries. In such as case, the result indicator may be accompanied by an indication of the number of attempts made by the affiliate to contact the past or present employer.

Another result indicator may be “DISCREPANCY FOUND,” indicating a discrepancy between the information in the work request and the information found by the affiliate. For example, the dates of employment or the title of the applicant discovered by the affiliate may be different from those on the work request.

Each of the above indicators may be accompanied by the supplemental indicator “ADDITIONAL INFORMATION FOUND.” This indicator may be included in the results if the affiliate discovered information not included in the work request. For example, in many cases, the applicant may not provide salary information from past or current employers. Therefore, no such information is contained in the work request. In the course of the verification, an affiliate may develop the salary information, either directly or indirectly. The supplemental indicator may be used to alert the control server and the client of such information.

The results are then forwarded to the requestor client (block 270) by, for example, posting the results to the requestor client on a website or sending the results in an electronic mail message.

Thus, the disclosed embodiments provide an efficient way to manage and distribute workload among any number of affiliates.

What is claimed is:

1. A method of distributing workload, comprising:
a) receiving a verification request from a client;
b) making the request electronically available to a plurality of affiliates;
c) transferring the request electronically to one or more of said plurality of affiliates for fulfillment of the request, said fulfillment including contacting at least one verifier included in the request; and
d) receiving results of the request fulfillment from the one or more affiliates.

2. The method of claim 1, wherein the request includes contact information for at least one verifier.

3. The method of claim 2, wherein at least one verifier is one of a past or current employer of the applicant, educational institution, business partner, reference, associate, co-worker, landlord, or creditor.

4. The method of claim 1, wherein the request received in step a) is received through a communication network.

5. The method of claim 4, wherein the communication network is the Internet.

6. The method of claim 1, further comprising:
after step a), accessing a data store to retrieve contact information for at least one verifier to facilitate fulfillment of the request.

7. The method of claim 1, further comprising:
after step d), updating a data store with contact information for at least one verifier included in the results.

8. The method of claim 1, further comprising:
transmitting the results to the requestor.

9. The method of claim 1, further comprising:
evaluating performance of one or more of said affiliates.

10. The method of claim 9, wherein the step of evaluating includes:
compiling statistics indicative of the performance.

11. The method of claim 1, further comprising:
comparing criteria associated with the work request with a profile of each of a plurality of affiliates,
wherein, in step b), the request is made available to a set of affiliates satisfying the criteria.

12. A program product, comprising machine readable program code for causing a machine to perform the following method steps:
a) receiving a verification request from a client;
b) making the request electronically available to a plurality of affiliates;
c) transferring the request electronically to one or more of said plurality of affiliates for fulfillment of the request, said fulfillment including contacting at least one verifier included in the request; and
d) receiving results of the request fulfillment from the one or more affiliates.

13. The program product of claim 12, wherein the request includes contact information for at least one verifier.

14. The program product of claim 13, wherein at least one verifier is one of a past or current employer of the applicant, educational institution, business partner, reference, associate, co-worker, landlord, or creditor.

15. The program product of claim 12, wherein the request received in step a) is received through a communication network.

16. The program product of claim 15, wherein the communication network is the Internet.

17. The program product of claim 12, further comprising machine readable program code for causing a machine to perform the following method step:
comparing criteria associated with the work request with a profile of each of a plurality of affiliates,
wherein, in step b), the request is made available to a set of affiliates satisfying the criteria.

18. A workload distribution system, comprising:
a central server adapted to receive a verification request from a client; and
a plurality of affiliate computers adapted to access the request from the server for fulfillment of the request, fulfillment of said request including contacting at least one verifier included in the request, the affiliate computers being further adapted to send results of results of the request fulfillment to the central server.

19. The system of claim 18, wherein the request includes contact information for at least one verifier.

20. The system of claim 19, wherein at least one verifier is one of a past or current employer of the applicant, educational institution, business partner, reference, associate, co-worker, landlord, or creditor.

21. The system of claim 18, wherein the central server is adapted to receive the request through a communication network.

22. The system of claim 21, wherein the communication network is the Internet.

23. The system of claim 18, further comprising:
a data store adapted to store contact information for at least one verifier to facilitate fulfillment of the request.

24. The system of claim 23, wherein the data store is adapted to be updated with contact information for at least one verifier included in the results.

25. The system of claim 18, further comprising:
an administrator module adapted to evaluate performance of one or more of said affiliates.

26. The system of claim 25, wherein the administrator module is adapted to compile statistics indicative of the performance.

27. The system of claim 18, further comprising:
a data store adapted to store profiles of each of said affiliates.

28. The system of claim 27, wherein said central server is adapted to compare said profiles with criteria associated with the work request to select candidate affiliates for the work request.
